(19) United States
(12) Patent Application Publication
(10) Pub. No.: US 2006/0151768 A1
(43) Pub. Date: Jul. 13, 2006

(54) Method and apparatus for deploying articles in deep waters

(76) Inventors: Gabriel A. Bursaux, Houston, TX (US); Stewart K. Willis, Aberdeenshire (GB); Vincent Alliot, Paris (FR); Ian Vennemann, Aberdeenshire (GB); Olav Vennemann, Aberdeen (GB)

Correspondence Address: SHERIDAN ROSS PC, 1560 BROADWAY, SUITE 1200, DENVER, CO, 80202, US

(21) Appl. No.: 10/506,392

(22) PCT Filed: Mar. 6, 2003
(86) PCT No.: PCT/GB03/00932

§ 371 Date: Jun. 14, 2005

(30) Foreign Application Priority Data
Mar. 6, 2002 (GB) 0205252.0

(51) Int. Cl. B66D 1/30

(52) U.S. Cl. 254/371

(57) ABSTRACT

A fibre rope is used for hoisting articles from a vessel (12) in deep waters. The fibre rope has substantially neutral buoyancy. The rope (14) is handled in vertical orientation by a track type tensioner (18) or moving clamps, in order to avoid bend cycling under load.

### INTRODUCTION

The invention relates to methods and apparatuses for deploying articles to great depth beneath the sea surface, for example to the seabed in deep waters.

Cranes and winches employing wire rope have been used to deploy loads to the seabed in modest water depth for many years. Some of these cranes and winch systems are fitted with, or used in conjunction with, heave compensators, which take-up and pay out the rope dynamically, to compensate vertical motion (heave) of the ship, barge or other platform from which the rope is supported.

As water depth increases, the weight of wire needed to lower equipment to the seabed increases until it becomes such a significant part of the total load that the method becomes impractical. Man made fibre rope can be almost neutrally buoyant and have strength and elastic characteristics similar to wire rope and is therefore potentially a suitable replacement for wire. Man made fibre rope, however, has a poor tolerance to the fatigue induced by bend cycling under load, and is thus unsuitable for use with current winch designs, particularly but not only those having heave compensation.

The present invention aims to provide novel methods and apparatus for using fibre rope, when deploying loads from a vessel at sea. A particular object for at least some embodiments of the invention is to provide methods that reduce bend cycling of the rope under load. A further aim is to allow operations to depths exceeding 300 m or 1000 m.

In broad terms, in one aspect of the invention a tensioning device mounted substantially vertically is used to grip the fibre rope, supporting the load and facilitating the payout of the rope.

The tensioning device may in particular be a continuous track system (linear winch) and can be made up from multiple units mounted around the fibre rope.

The tensioning device may alternatively comprise at least one clamp comprising a plurality of pads arranged longitudinally and circumferentially around the fibre rope, and mounted on a movable carriage

Substantially the entire load in the fibre rope is taken by the tensioning system; the rope entering the tensioning system is not under substantial load. This allows the fibre rope to be stored on a storage reel or carousel without bending under load. Of course some back-tension may be maintained on the reel for control of the rope.

The tensioning device may have a general form and features in common with clamps and/or track-type tensioners used conventionally for pipe laying operations. In preferred embodiments, however, at least the shoes of the tensioner are specially adapted to the different characteristics of the fibre rope, and would not be suitable for smooth conduit.

Several specific adaptations of tensioner and clamp are described below, by way of example only. These may be used individually or in any combination, and the invention does not exclude other adaptations, nor the use of an existing pipelay tensioner.

The tensioner may be mounted so as to suspend the rope from beside the vessel, or via a moonpool. A tower arrangement for vertical deployment of flexible conduit through a moonpool is known for example from WO 91/15699 A (Coflexip). As is also known in the pipe laying art, vertical or steeply inclined towers of other constructions can be applied. “Vertical” in the present context is intended to encompass a range of deviation from the vertical, particularly (i) the load for whatever reason acts in a direction inclined from the vertical (in which case the tensioner may be tilted to aligned with the load direction) and (ii) where fatigue under bend cycling is serious only beyond a certain bend angle. An offset tower permitting pipelay with an inclined tensioner is known for example from WO 02/57675 A.

Tower arrangements providing a pair of moving clamps are disclosed in WO 99/35429 A (Coflexip) and in our co-pending application GB 0302279.5, not published at the present priority date. Suitable clamps are described in our co-pending application GB 2 364 758 A (63566 GB). The contents of these documents are hereby incorporated herein by reference.

### BRIEF DESCRIPTION OF THE DRAWINGS

Embodiments of the invention will now be described, by way of example only, by reference to the accompanying drawings, in which:

FIG. 1 is a schematic diagram illustrating the general arrangement of a rope-based lifting and lowering apparatus including a vertical tensioner according to an embodiment the present invention;

FIG. 2, shows a gripping pad design suitable for use in a number of embodiments of the invention;

FIGS. 3, 4 and 5 shows an arrangement using three of the pads of FIG. 2 in various stages of operation;

FIG. 6 shows an abandonment and recovery system using moveable clamps to hold the rope;

FIGS. 7, 8 and 9 show schematically three specific adaptations of the tensioner within the apparatus of FIG. 1

### DETAILED DESCRIPTION OF EXEMPLARY EMBODIMENTS

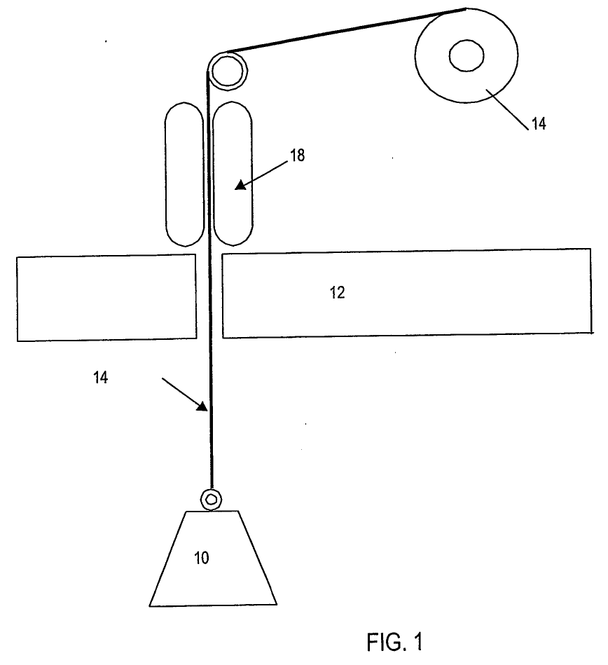

FIG. 1 provides an overview of the deployment system which is used to lower a load 10 to the seabed from a ship, barge or other sea-borne vessel 12. Fibre rope 14 is stored in a spooling system 16, which does not serve as a winch for the weight of the load 10, however. A continuous track tensioner 18 engages the rope 16 by friction and or other means and provides the tension for controlled lowering or lifting of the load.

Tracks or the like arrayed around the axis of the rope 14 are pressed radially inward by suitable rams, levers and the like to grip the rope, and to release it again when required. Each track comprises a series of individual shoes linked together. While two tracks are shown for the sake of illustration, three or four tracks will be more usually provided, spaced at 120° or 90° intervals around the rope axis respectively.

The detailed construction and operation of the structures for supporting these tensioners in vertical and/or inclined positions above the sea surface can be readily envisaged by the skilled person, for example by reference to prior art in the field of pipe and cable laying, including those documents mentioned already above.

Ideally, to use fibre rope in combination with a multi-track tensioner, equipped with pads on the tracks, the pad design should be adapted to the rope. A rope behaves different than, say, an umbilical or pipeline (flexible or rigid), when it is fed through a tensioner, compressed by the pads and brought under tension. Unlike pipes and umbilicals, the diameter of the rope can change significantly with increasing load onto the pads as well as with increasing tension to the rope. Furthermore the danger of pinching the rope between the pads is significant. Therefore a proper fit of the rope between the pads should be always ensured, regardless of the load to the pads or the tension to the rope.

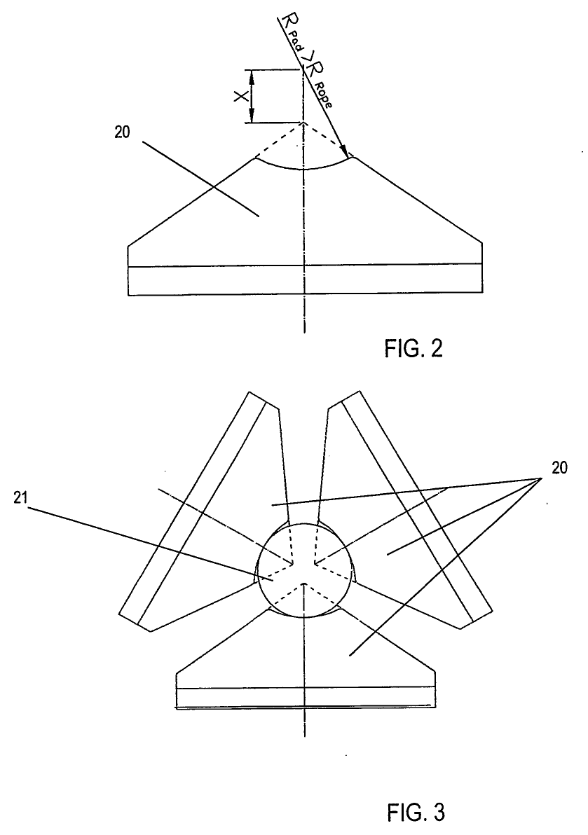

FIG. 2 shows a novel design of a pad, adapted to the behaviour of the fibre rope. The radius R_{pad} contact surface of the pads is bigger than the nominal radius Rᵣₒₚₑ of the rope, and the centre of the radius of curvature is beyond the centre of the rope when the pads are brought into contact with the rope. In this way the cross sectional area is smaller than the calculated circular area of the radius on the pad (πr²). When the pads are closed, the cross sectional area has an approximately triangular shape. This is beneficial in order to avoid pinching of the rope between the pads when approaching. For a four-track tensioner; the shape will be square.

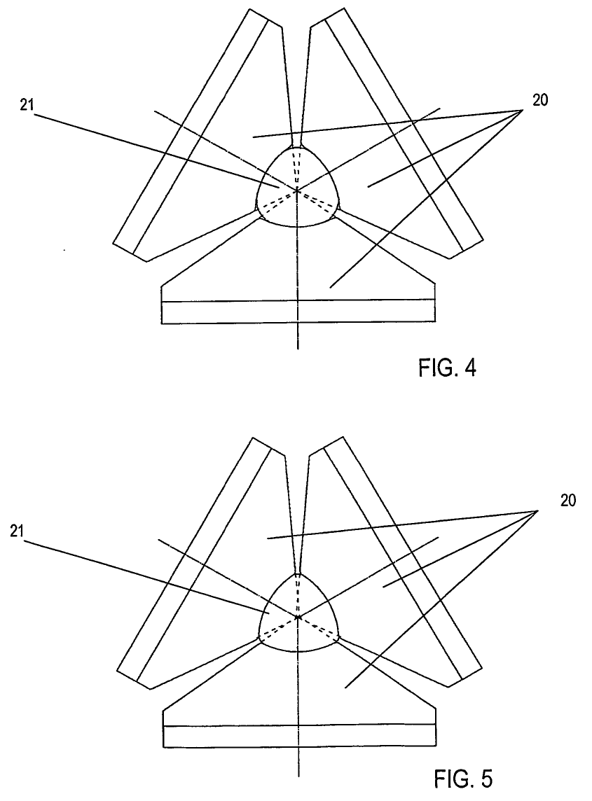

FIG. 3 shows three of the pads 20 in use contacting a rope 21. The first contact of the rope and the pads will occur in the middle of the radius area. By further closing the pads (moving to the centre line) the rope will change its shape to a slightly triangular shape. On this stage the rope starts to get compressed at the areas of initial contact (see FIG. 4.). Compression of the rope starts in the middle of the contact area of the pads to the rope, when load to the pads will be applied. The cross sectional area of the rope reduces as the pads move closer to the centre line and the rope gets compressed. The bigger radius on the pads avoids a pinching of the rope between the pads when moving closer. When fully closed (still without pads in contact to each other) the cross sectional area is much less than for the unsqueezed rope (see FIG. 5).

This will happen even under tension of the rope. According to this, the cross sectional area described by the closed pads needs to be less than the nominal cross sectional area of the rope.

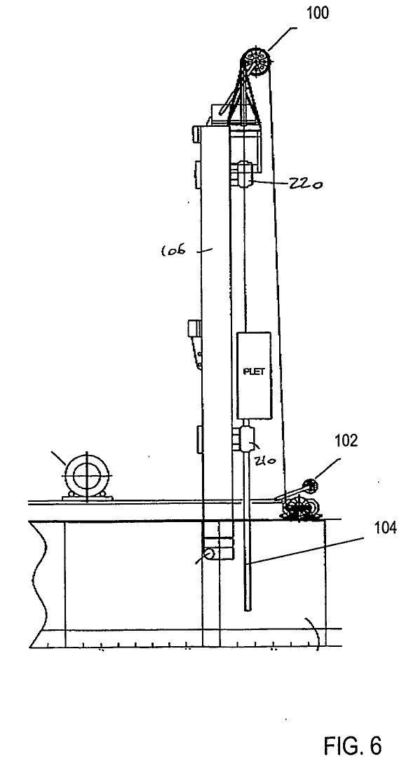

FIG. 6 shows another installation where the track type tensioner is replaced by a movable clamp or preferably a pair of clamps, to pay out or haul in the fibre rope. This shows a tower 106 with a winch 100 mounted at the top. The fibre rope on this which 100 is sourced from a spool 102. It is connected to a load (in this case the end of a pipeline 104, via a pipeline end termination (PLET)). Two clamps 210, 220 having the novel pad arrangement as described above hold the rope. Again, the clamp may be formed in two, three or four sections. The same clamps have been used to lay the pipeline, and then adapted by changing their shoes to handle the fibre rope for abandonment of the pipeline.

During deployment and/or recovery both clamps 210, 220 move relative to each other, in a sequential manner to and from the middle of the tower, to hand over the grip on the rope from one clamp to the other. This action results in the paying in or out of the rope, and can be controlled to provide continuous movement. (With a single movable clamp and a fixed clamp, only intermittent movement could be achieved.)

Three other possibilities have been considered for adapting the tensioner specifically for gripping of the fibre rope.

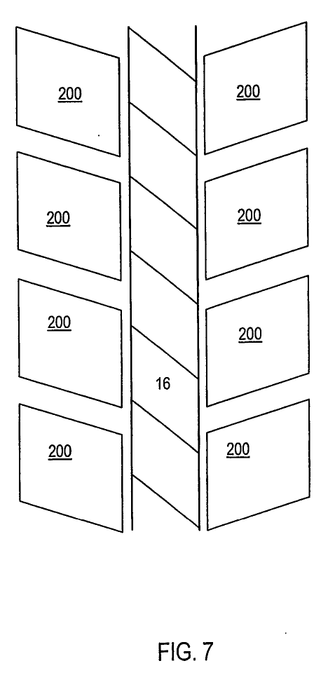

FIG. 7 shows a further adaptation of the tensioner gripping pads 200 which are made deformable. The deformation under radial pressure accommodates for example the braided surface variations of the rope, while also engaging them to assist in transferring tension from the rope to the hoist. This adaptation may be combined with the novel form described above, if desired, and may be used as movable clamps as well as track tensioner.

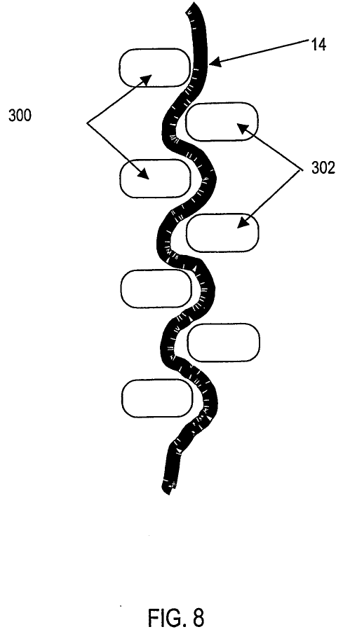

FIG. 8 shows another adaptation in which the arrays of gripping elements 300 and 302 of the tensioner on opposite sides of the rope axis are staggered so as to induce snaking of the rope 14 under radial gripping pressure.

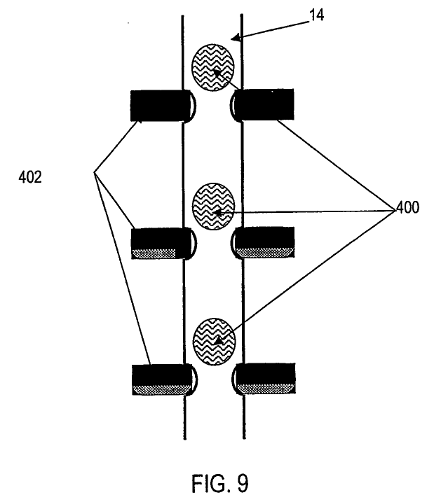

FIG. 9 shows another adaptation, in which stoppers 400 are embedded in the rope 14 at intervals along its length. The rope may be gripped by elements 402 of the tensioner 18 having corresponding spacing.

The above adaptations are provided by way of example only, and the skilled reader will appreciate that other arrangements are possible within the spirit and scope of the invention. In particular, it will be noted that the adaptations of FIGS. 7, 8 and 9 can be used alone or in combination. Thus, for example, gripping elements 300, 302 and 402 of FIGS. 8 and 9 can be made deformable in the manner of FIG. 7. Similarly, elements 400 and 402 of the FIG. 4 arrangement can be provided in staggered arrays, for example at right angles to one another about the rope axis.

The method can be applied beneficially in oil & gas field development (sub-sea construction) in depths beyond 300 m. General lifting and lowering operations can also be envisaged in depths down to full oceanic depth, for example for Salvage, Oceanography, and Military purposes.

1. Apparatus for supporting loads from a vessel at sea using fibre rope, said apparatus including a tensioning device mounted substantially vertically used to grip the fibre rope, said tensioning device supporting the load and facilitating the paying out and hauling in of the rope.

2. Apparatus as claimed in claim 1 wherein said tensioning device comprises multiple units mounted around the fibre rope axis, each having at least one contact pad for engaging the fibre rope over a corresponding part of its circumference.

3. Apparatus as claimed in claim 2 wherein the or each contact pad has a curved contact surface whose radius of curvature is substantially greater than the radius at which the pad is arranged to engage the rope.

4. Apparatus as claimed in claim 2 wherein the or each contact pad has a curved contact surface which subtends an angle of arc substantially less than one whole circle divided by the number of units mounted around the fibre rope axis.

5. Apparatus as claimed in claim 3 wherein there are provided three units whose contact surfaces when brought together form a shape that is substantially triangular with sides curved outwards.

6. Apparatus as claimed in claim 3 wherein there are provided four units whose contact surfaces when brought together form a shape that is substantially square with sides curved outwards.

7. Apparatus as claimed in claim 2 wherein each unit of the tensioning device comprises a plurality of segments connected to form a continuous track.

8. Apparatus as claimed in claim 2 wherein said tensioning device comprises at least one clamp mounted so as to be movable under load in the direction of the rope axis.

9. Apparatus as claimed in claim 8 wherein there are provided two clamps which are operable to move relative to each other in a sequential manner upwardly and downwardly, and to hand over the grip on the rope from one clamp to the other so as to achieve continuous movement of the rope and load.

10. Apparatus as claimed in claim 1 wherein said tensioning device has a form and features suitable for pipe laying operations, but provided with shoes specially adapted for the characteristics of the fibre rope.

11. Apparatus as claimed in claim 1 wherein a storage reel for said fibre rope is arranged such that substantially the entire load in the fibre rope is taken by said tensioning device.

12. Apparatus as claimed in claim 11 operable such that some back-tension is maintained on the reel for control of the rope.

13. Apparatus as claimed in claim 1 wherein the tensioning device is mounted so as to suspend the rope from beside the vessel.

14. Apparatus as claimed in claim 1 wherein the tensioning device is mounted so as to suspend the rope via a moonpool.

15. Apparatus as claimed in claim 1 wherein contact pads of said tensioning device are made deformable.

16. Apparatus as claimed in claim 1 wherein arrays of contact elements of said tensioning device on opposite sides of the rope axis are staggered so as to induce snaking of the rope under radial gripping pressure.

17. Apparatus as claimed in claim 1 in combination with a rope having stoppers embedded in the rope at intervals along its length.

18. Apparatus as claimed in claim 17 wherein gripping elements of the tensioning device having spacing corresponding to said stoppers.

19. A method of supporting a load from a vessel at sea using fibre rope wherein a tensioning device mounted is substantially vertically and used to grip the fibre rope, said tensioning device supporting the load and facilitating the paying out and hauling y-in of the rope.

20. A method as claimed in claim 19 wherein substantially the entire load in the fibre rope is taken by said tensioning device, and parts of the rope under tension are not diverted substantially from vertical.

21. A method as claimed in claim 20 wherein some back-tension is maintained on the reel for control of the rope.

22. A method as claimed in claim 19, wherein the tensioning device is adapted as claimed in claim 3.

23. (canceled)

24. Gripping arrangement for a fibre rope wherein there is provided a plurality of contact pads, said pads being arranged longitudinally and circumferentially around the fibre rope axis and wherein the contact area of each pad is curved and the radius of curvature of the contact surface of each pad is substantially greater than the radius at which the pad is arranged to engage the rope.

25. Gripping pad arrangement for a fibre rope wherein there is provided a plurality of pads, said pads being arranged longitudinally and circumferentially around the fibre rope axis and wherein the contact area of each pad is curved and the angle of are suspended by the curved surface of each pad is substantially less than one whole circle divided by the number of units.

26. Gripping pad arrangement as claimed in claim 25 wherein there are provided groups of three pads arranged around the rope axis to form when brought together a shape that is substantially triangular with sides curved outwards.

27. Gripping pad arrangement as claimed in claim 25 wherein there are provided four pads arranged to form when brought together a shape that is substantially square with sides curved outwards.
